(19) United States
(12) Patent Application Publication
(10) Pub. No.: US 2019/0271820 A1
(43) Pub. Date: Sep. 5, 2019

(54) FIBER OPTIC PLUG AND FIBER OPTIC CONNECTION ASSEMBLY

(71) Applicant: Hirose Electric Co., Ltd., Tokyo (JP)

(72) Inventor: Hiroshi TANOOKA, Tokyo (JP)

(73) Assignee: Hirose Electric Co., Ltd.

(21) Appl. No.: 16/289,990

(22) Filed: Mar. 1, 2019

(30) Foreign Application Priority Data
Mar. 2, 2018 (JP) 2018-037139

(51) Int. Cl. G02B 6/42

(52) U.S. Cl. CPC G02B 6/4292; G02B 6/423

(57) ABSTRACT

Plug housing with retaining portion having a cylindrical sleeve portion securing in place a core exposed by stripping a sheath from a front end portion of a fiber optic cable. Sleeve portion, at multiple locations in the circumferential direction, has multiple elastic retaining pieces with slits extending from an intermediate location in the axial direction of the sleeve portion to its front end, and a minimum inside diameter portion in the inside diameter during elastic displacement of the elastic retaining pieces throughout the extent of the slits in the axial direction. During the mating of the retaining portion and receptacle, while the front end of the core is positioned forwardly of the minimum diameter portion or at the minimum inside diameter portion, sleeve portion undergoes forces originating in the receptacle, and elastic retaining pieces are elastically displaced in the radial inward direction of the sleeve portion, thereby securing the core.

### CROSS REFERENCE TO RELATED APPLICATIONS

This Paris Convention Patent Application claims benefit under 35 U.S.C. § 119 and claims priority to Japanese Patent Application No. JP 2018-037139, filed on Mar. 2, 2018, titled “FIBER OPTIC PLUG AND FIBER OPTIC CONNECTION ASSEMBLY”, the content of which is incorporated herein in its entirety by reference for all purposes.

### BACKGROUND

### Technical Field

The present invention relates to a fiber optic plug and a fiber optic connection assembly comprising a fiber optic plug and a receptacle serving as a counterpart connector component.

### Related Art

A fiber optic plug has been disclosed, for example, in Patent Document 1. In Patent Document 1, a plug is formed such that a fiber optic cable is secured in place within its housing, and said plug is mated with a counterpart connector component, for example, a receptacle such as the one illustrated in FIG. 6 of Patent Document 1. Prior to the fiber optic cable being secured within the plug housing, the front end portion of said fiber optic cable is stripped of its sheath to form an exposed section of the optical fiber (core) called “bare fiber”. In this state, a section of the sheath located just behind this exposed section is secured in place using a cable retainer. In the front portion, the housing has a sleeve-shaped fiber retaining portion that secures in place the exposed bare fiber and, in the rear portion, has an aperture portion that receives the cable retainer that secures the sheath in place. After inserting the bare fiber into the fiber retaining portion, said bare fiber, once its front end face has been made flush with the front end face of the fiber retaining portion, is fixed to said fiber retaining portion using an adhesive agent. The cable retainer is received in the aperture portion and is secured in place within said housing because pawl elements provided in said cable retainer engage the inner surface of the aperture portion of the housing and prevent extraction.

### PRIOR ART LITERATURE

### Patent Documents

### [Patent Document 1]

Japanese Patent Application Publication No. 2015-055731

### SUMMARY

### Problems to be Solved

As in the case of electrical wire connections in various other electrical connectors, when a fiber optic plug of this type is used, in addition to the requirement that the fiber optic cable be connected in an efficient manner, there is the requirement that when the fiber optic plug is mated with a receptacle, precise optical axis alignment is needed between the fiber optic cable, lenses, and other optical components secured in place in the receptacle and the core (optical fiber) of the fiber optic plug.

However, in Patent Document 1, the bare fiber (exposed core) in the plug is inserted in the opening of the fiber retaining portion of the cable retainer and fixed using an adhesive agent. Securing as such with adhesive requires time for the application and drying of the adhesive and, in addition to being laborious, leads to poor operational efficiency and low productivity. Furthermore, although the bare fiber is securely fixed in place, a clearance needs to be provided for the entry of the adhesive agent between the bare fiber and the opening in the fiber retaining portion, which causes random variation in the accuracy of radial placement of the fixed bare fiber from one plug to the next.

Thus, in Patent Document 1, there is room for improvement in terms of productivity and accuracy during plug manufacture.

In view of these circumstances, it is an object of the present invention to provide a fiber optic plug and a fiber optic connection assembly capable of ensuring high productivity and high positioning accuracy.

### Technical Solution

The inventive fiber optic plug and fiber optic connection assembly are configured as follows.

### <Fiber Optic Plug>

The inventive fiber optic plug whose plug housing, which secures a fiber optic cable in place and engages with a receptacle serving as a counterpart connector component, has a retaining portion securing the fiber optic cable in place, guided portions guided by receiving portions formed in the receptacle, and engageable portions engaging with the receptacle and preventing extraction after mating.

In such a fiber optic plug, in this invention, the above-mentioned retaining portion has a cylindrical sleeve portion that secures in place a core exposed by stripping a sheath from a front end portion of the fiber optic cable; said sleeve portion, at multiple locations in the circumferential direction, has provided therein multiple elastic retaining pieces formed having slits extending from an intermediate location in the axial direction of said sleeve portion to its front end; the above-mentioned sleeve portion has a minimum inside diameter portion formed in the inside diameter during elastic displacement of the elastic retaining pieces throughout the extent of the slits in the above-mentioned axial direction, and, during the mating of the above-mentioned retaining portion with the above-mentioned receptacle, while the front end of the core is at a position located forwardly of the above-mentioned minimum diameter portion or at the same position as said minimum inside diameter portion, the above-mentioned sleeve portion is subject to forces originating in the receptacle, and the elastic retaining pieces are elastically displaced in the radial inward direction of said sleeve portion, thereby securing the core in place.

In the thus-configured inventive fiber optic plug, when the fiber optic plug is mated with the receptacle, the sleeve portion is reduced in diameter as a result of elastic displacement of the elastic retaining pieces, forming the sleeve portion such that the elastic retaining pieces intimately adhere to the core of the fiber optic cable in the above-mentioned minimum inside diameter portion and the front end portion or front end of the core is directly and tightly secured in place by the sleeve portion. In this manner, in addition to the high accuracy of radial positioning (retention) obtained because at least the above-mentioned minimum inside diameter portion requires no clearance for the adhesive agent, as was done in the past, good working efficiency and increased productivity are achieved because no adhesive agents are used.

In the present invention, the retaining portion, guided portions, and engageable portions of the plug housing can be formed either as a single member or, alternatively, as separate members that are subsequently assembled together.

### <Fiber Optic Connection Assembly>

The inventive fiber optic connection assembly is characterized by the fact that the fiber optic connection assembly is adapted to comprise a fiber optic plug such as the one described above and a receptacle with which said fiber optic plug is mated, the receptacle has a receiving portion that receives the cylindrical sleeve portion provided in the retaining portion of the plug housing, and said receiving portion is formed as a cylindrical opening having a section with an inside diameter smaller than the outer peripheral surface of the sleeve portion.

In the thus-configured inventive fiber optic connection assembly, by simply introducing the sleeve portion of the fiber optic plug into the receiving portion of the receptacle, the diameter of the sleeve portion is reduced and the core is reliably secured in place by the sleeve portion.

In the present invention, the receiving portion of the receptacle is formed as a cylindrical opening having multiple planar portions distributed in the circumferential direction along its inner peripheral surface and the distance between the axial line of said cylindrical opening and said planar portions can be made smaller than the radius of the outer peripheral surface of the sleeve portion of the fiber optic plug. As a result, if the accuracy of the distance between the planar portions and the axial line is ensured, sections other than the planar portions do not need to be accurate, which facilitates fabrication in comparison with using a completely cylindrical inner surface with a precision-finished inside diameter along its entire periphery.

### Technical Effect

In the present invention, as described above, as a result of reducing the diameter of the multiple elastic retaining pieces formed having the slits in the sleeve portion when said fiber optic plug is mated with the receptacle of the fiber optic plug, the core is rigidly secured in place in the minimum inside diameter portion in a state of close adherence to said core of the fiber optic cable, and for this reason, the core is rigidly secured by the sleeve portion in a stable position. Since the sleeve portion can be made with high precision, it is possible to obtain a fiber optic plug that secures the core in place in a precise location, and, in addition, it is possible to obtain a fiber optic connection assembly in which the optical axis of the plug is accurately matched with the optical axis of the optical components of the receptacle when the plug is mated with the receptacle. In addition, since no adhesive is used to hold the core in the sleeve portion, the efficiency of fiber optic plug fabrication is increased.

### BRIEF DESCRIPTION OF DRAWINGS

FIG. 1 A perspective view illustrating the appearance of a fiber optic plug used in an embodiment of the present invention mated with a receptacle serving as a counterpart connector component.

FIG. 2 A perspective view illustrating the appearance of the fiber optic plug and receptacle of FIG. 1 in a state prior to mating.

FIG. 3 A perspective view of a cross-section taken in a plane comprising the axial line of the fiber optic plug and receptacle of FIG. 1 in a mated state.

FIG. 4 A perspective view of a cross-section taken in a plane comprising the axial line of the fiber optic plug and receptacle of FIG. 1 in a state prior to mating.

FIG. 5 A cross-sectional view taken in a plane comprising the axial line of the fiber optic plug and receptacle of FIG. 1 in a mated state, with the essential portions enlarged.

FIG. 6 A cross-sectional view taken in a plane comprising the axial line of the fiber optic plug and receptacle of FIG. 1 in a state prior to mating, with the essential portions enlarged.

FIG. 7 A cross-sectional view taken along line VII-VII in FIG. 5.

FIG. 8 A cross-sectional view taken along line VIII-VIII in FIG. 6.

### DETAILED DESCRIPTION

Embodiments of the present invention will be discussed below with reference to the accompanying drawings.

In order to clearly identify directions in the drawings, 3D spatial coordinates XYZ are used, such that X is the direction in which the optical fiber extends, in other words, the axial direction of mating and unmating of the fiber optic plug and receptacle, Y is the width direction of the fiber optic plug and receptacle parallel to a circuit board surface and perpendicular to X, and Z is the heightwise direction perpendicular to X and Y. In addition, in the description of the fiber optic plug, the direction oriented toward the receptacle in the above-mentioned axial direction X is referred to as the forward direction.

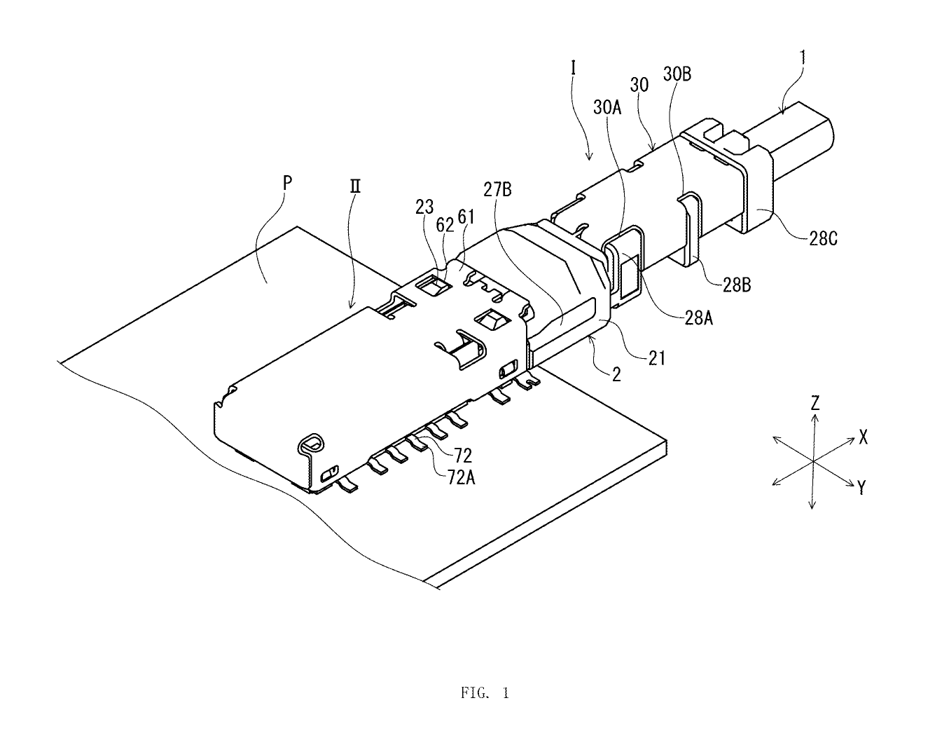

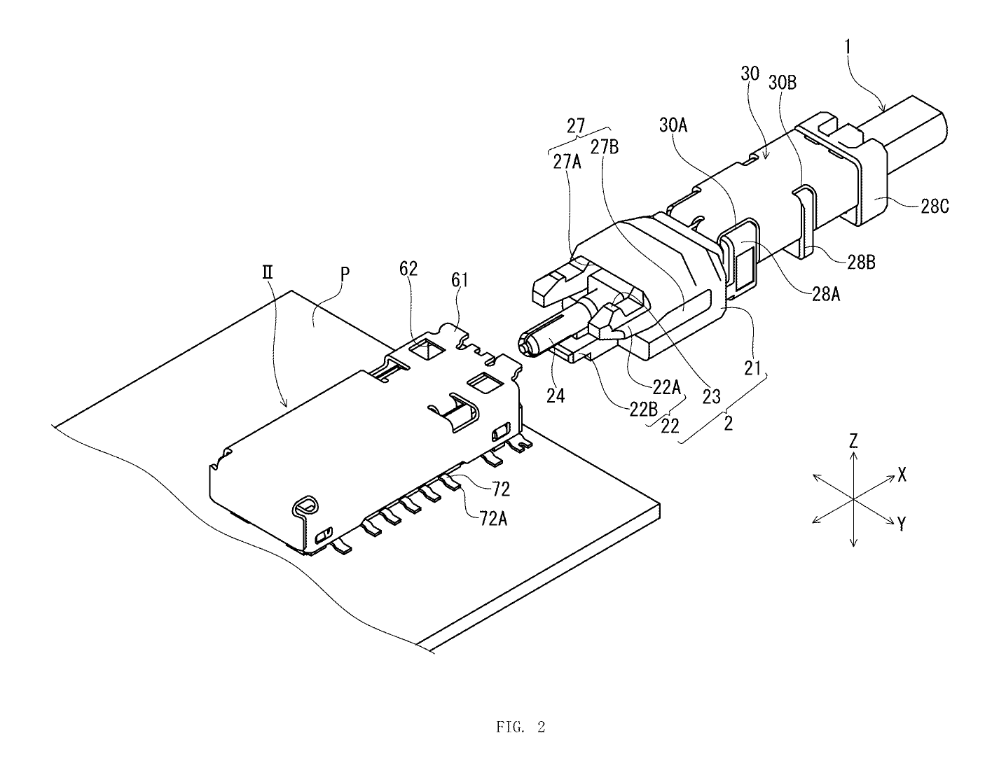

In FIG. 1, the receptacle II is mounted to a circuit board P, and the fiber optic plug I, which holds the optical fiber in place, is mated with the above-mentioned receptacle II. FIG. 2 illustrates a state prior to mating, or after unmating the fiber optic plug I from the receptacle II.

In the fiber optic plug I, the fiber optic cable 1 is secured in place in the plug housing 2, and said plug housing 2 is mated with the receptacle II in its front portion.

As can be seen in FIG. 2, the plug housing 2 that mates with the receptacle II has a retaining portion 21, which secures the fiber optic cable 1 in place, guided portions 22, which are guided and mated with receiving portions formed in the receptacle II, and engageable portions 23, which prevent extraction after mating with the receptacle II.

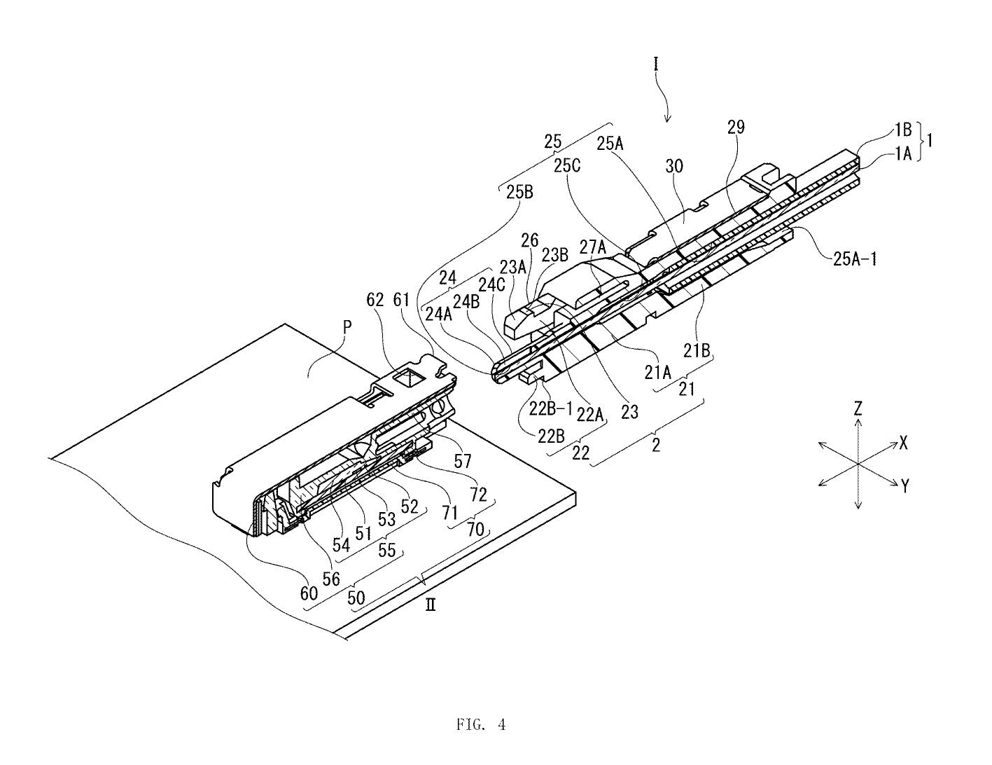

As can be seen in FIG. 4, the retaining portion 21 has a sleeve portion 24 shaped as a substantially tubular body protruding forwardly in the axial direction X toward the receptacle II at the front end of the retaining portion 21. A cable-retaining opening 25 used to hold the fiber optic cable 1 is formed passing therethrough and extending in the axial direction X from the front end of the sleeve portion 24 to the rear end of said retaining portion 21. The external configuration of the retaining portion 21 located behind said sleeve portion 24 in a cross-section perpendicular to the axial direction X is a rectangle, whose dimensions in the width direction Y are larger than those in the heightwise direction Z, and which extends lengthwise in the axial direction X.

As can be seen in FIG. 4, the above-mentioned cable-retaining opening 25 includes a rear retaining opening 25A, which houses the fiber optic cable 1, not stripped of its sheath 1B, in its rear portion located away from the receptacle II along the axial line X, a front retaining opening 25B, which houses the core 1A exposed as a result of stripping the sheath 1B from the front end portion of the fiber optic cable 1, and an intermediate retaining opening 25C, whose inside diameter at a location between the above-mentioned rear retaining opening 25A and front retaining opening 25B is larger than that of said front retaining opening 25B and smaller than that of the above-mentioned rear retaining opening 25A. Said intermediate retaining opening 25C has a tapered stepped configuration whose inside diameter is forwardly reduced in the axial direction X and is in communication with the above-mentioned front retaining opening 25B.

The rear retaining opening 25A of the above-mentioned cable-retaining opening 25 has formed therein a cable insertion portion 25A-1, whose inside diameter is widened via a tapering portion such that toward the rear end its diameter becomes larger than that of the sheath of the optical fiber.

The sleeve portion 24, which has a cylindrical outer peripheral surface, is provided protruding forwardly from the front end of the above-mentioned retaining portion 21 at the intermediate location of the above-mentioned front retaining opening 25B in the axial direction X. As can be seen in FIGS. 2, 4, and 6, the outer peripheral surface of the front end of said sleeve portion 24 has formed therein a narrowing tapering surface 24A, and slits 24B extending from intermediate locations in the axial direction X to the front end are formed at three equidistant locations in the circumferential direction. Throughout the range of these slits 24B in the axial direction X, said slits 24B split the above-mentioned sleeve portion 24 into multiple (three in the illustrated example) sections in the circumferential direction, thereby forming elastic retaining pieces 24C extending in the above-mentioned axial direction X to the front end of the sleeve portion 24. The multiple elastic retaining pieces 24C have formed therein a cylindrical opening, whose inside diameter in a free state in which they are not subject to elastic deformation is practically the same as the outside diameter of the core 1A and which extends in the axial direction X, thereby enabling insertion of said core 1A. Although in the free state the inside diameter of the sleeve portion 24 is the same at any location in the axial direction X, during radial inward elastic deformation of the elastic retaining pieces 24C, said elastic retaining pieces 24C assume a cantilever configuration and, therefore, form a minimum inside diameter portion at the front end. The outside diameter of the above-mentioned sleeve portion 24, in other words, the diameter of the common outer peripheral surface of the multiple elastic retaining pieces 24C, is set to a thickness (radial dimensions) within which the above-mentioned elastic retaining pieces 24C are elastically deformable by a force directed radially inward and, additionally, a thickness at which the core 1A is tightly secured in place with sufficient strength during elastic deformation.

The above-mentioned retaining portion 21 has a front portion 21A and a rear portion 21B, and, as can be appreciated from FIG. 4, the front portion 21A is larger than the rear portion 21B in the width direction Y and the heightwise direction Z.

In the front portion 21A, the front end of the lower section located below the cable-retaining opening 25 is located forwardly of the front end of the top section located above the cable-retaining opening 25, and arm portions 26 extend forwardly from the front end of the above-mentioned top section at both ends in the width direction Y, with their lateral faces constituting upper guided portions 22A intended to cooperate with the receptacle II. A plate-shaped lower guided portion 22B projects forwardly from the front end of the above-mentioned lower section at a central location in the width direction Y. The above-mentioned upper guided portions 22A and lower guided portion 22B constitute the guided portions 22 of the fiber optic plug I. The upper guided portions 22A, which form the lateral faces of the above-mentioned arm portions 26, are restricted by the receptacle II in the width direction Y while being guided in the axial direction X, and the above-mentioned lower guided portion 22B is restricted by the receptacle II in the heightwise direction Z while being guided in the axial direction X. A stepped portion 22B-1, which is located in the base portion of the above-mentioned lower guided portion 22B, abuts the corresponding portion of the receptacle II, thereby ensuring accurate positioning in the axial direction X during mating.

The above-mentioned arm portions 26 have barb-like engageable portions 23 on their upper faces. Said engageable portions 23, which have guided tapering surfaces 23A that slope forwardly downward, and engageable stepped portions 23B that are formed posteriorly thereof, are guided by the above-mentioned guided tapering surfaces 23A to the engaging portions of the receptacle II and engage therewith through the medium of the engageable stepped portions 23B, thereby preventing rearward extraction.

As can be seen in FIG. 2, groove portions 27, which are open forwardly in the axial direction X and laterally in the width direction Y, are formed in the front portion 21A of the retaining portion 21. Said groove portions 27 include an upper groove portion 27A, which is located above the cable-retaining opening 25 in the heightwise direction Z in the range between the two arm portions 26 in the width direction Y (see also FIG. 4), and a lower groove portion 27B, which is located below the above-mentioned cable-retaining opening 25 in the range between the above-mentioned two arm portions 26 in the width direction Y, with the upper groove portion 27A and lower groove portion 27B being in communication with each other in the heightwise direction Z. As far as said groove portions 27 are concerned, in the relatively robust front portion 21A, the top section located above the groove portion 27 imparts elasticity to the arm portions 26 in the heightwise direction Z and enables elastic flexural deformation of said arm portions 26 during mating with the receptacle II. In this manner, downward displacement of the above-described engageable portions 23 under the action of the force of abutment of the receptacle II against the guided tapering surfaces 23A enables mating with the receptacle II, and, upon reaching the engaging portions of the hereinafter described receptacle II, the elastic flexural deformation of the above-mentioned arm portions 26 is released and engagement with the engaging portions of the above-mentioned receptacle II is effected through the medium of the engageable stepped portions 23B, thereby preventing extraction.

As can be seen in FIGS. 1 and 2, the rear portion 21B of the retaining portion 21 is provided with ribs 28A, 28B, and 28C at the front end, at an intermediate location, and at the rear end. The ribs 28A and 28B are provided on the lateral faces of the retaining portion 21 (faces located at both ends in the width direction Y), and the rib 28C is provided on the upper and lateral faces thereof. Thus, a fitting mounting surface 29 recessed by the extent of protrusion of the above-mentioned ribs 28A, 28B, and 28C is formed on the upper and lateral faces of the retaining portion 21. The ribs 28A, 28B, and 28C define the location of mounting of the hereinafter described fitting (see FIG. 4).

The fitting 30 is mounted to the above-mentioned fitting mounting surface 29. Said fitting 30 is fabricated by bending a metal sheet downwardly in a U-shaped configuration, with notched portions 30A and 30B formed at the locations and within the range corresponding to the above-mentioned ribs 28A and 28B. In this manner, the fitting 30 is mounted such that it is positioned in close adherence to the above-mentioned fitting mounting surface 29 and helps reinforce the retaining portion 21.

As can be seen in FIGS. 2 and 4, the receptacle II that serves as a counterpart connector component with which the thus-configured fiber optic plug I is mated has a mounting connector 70 attached to the circuit board P, and a connector main body 50, which is assembled together with said mounting connector 70, receives the fiber optic plug I, and is directly connected to said fiber optic plug I. Since the embodiments of the present invention associated with the reception of the fiber optic plug I and connection to said fiber optic plug I in the receptacle II are of particular importance, the discussion below will describe these points in detail while illustrating other issues in a concise manner. In describing the receptacle II, the direction oriented toward the fiber optic plug I will be defined as “forward”.

On the surface of the board 51, the connector main body 50 has a light-receiving element 52, such as a photo diode or the like, and an actuation device 53, which is used to electrically drive said light-receiving element 52. Said actuation device 53 is connected to terminals (not shown) provided on the board 51, with said terminals projecting from the board 51 to enable connection to the above-mentioned mounting connector 70. All these elements, which are molded integrally with the above-mentioned board 51 using transparent resin 54 to thereby form a first molding 55, are secured to said board 51 and protected by this transparent resin 54.

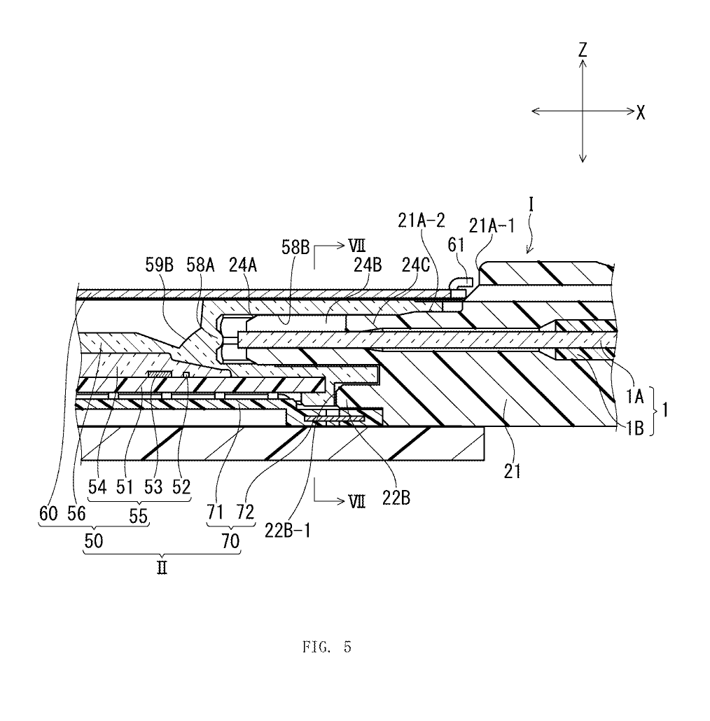

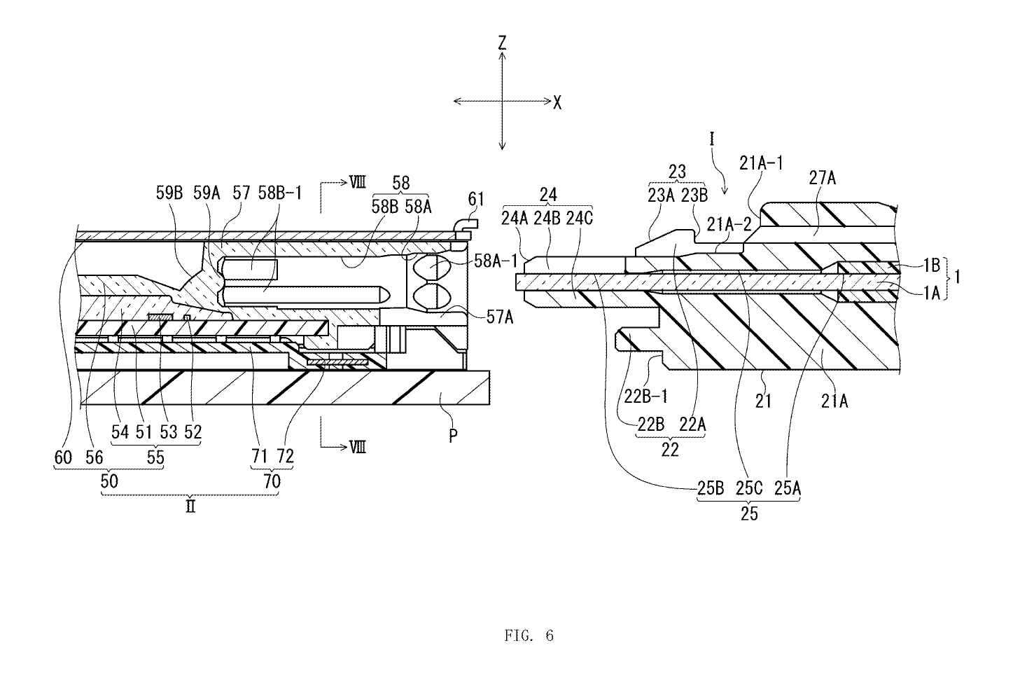

The above-mentioned connector main body 50 has a second molding 56, in which transparent resin is molded integrally with the above-mentioned first molding 55, and a receiving tubular portion 57, which is formed from this transparent resin and extends toward the fiber optic plug I. As can be seen in FIGS. 5 and 6, in this receiving tubular portion 57, a lens portion 59A and a reflection surface 59B are molded integrally with the receiving portion 58 receiving the fiber optic plug I using the above-mentioned transparent resin.

The receiving portion 58, which is formed by the inner surface of the above-mentioned receiving tubular portion 57, is open forwardly toward the fiber optic plug I and extends in the axial direction X. The lens portion 59A and, posteriorly thereof, the reflection surface 59B, are provided in the bottom portion of said receiving portion 58.

The above-mentioned receiving portion 58 has an insertion portion 58A, which is located in the front portion adjacent the aperture portion, and a receiving opening 58B, which is located in the rear portion immediately behind said insertion portion 58A in the axial direction X. The above-mentioned insertion portion 58A has an inside diameter that is larger than that of the receiving opening 58B. The aperture of the insertion portion 58A, which has a maximum inside diameter at the front end and has its inside diameter successively reduced in a stepped manner in the rearward direction, is connected to the above-mentioned receiving opening 58B when its inside diameter is made equal to that of said receiving opening 58B. Local planar portions 58A-1 are formed in the insertion portion 58A at multiple locations in the circumferential direction of its inner peripheral surface. Slits 57A, which extend in the axial direction X, are formed at multiple locations in the circumferential direction in the receiving tubular portion 57 throughout the extent of this insertion portion 58A in the axial direction X. These slits 57A make it possible for the receiving tubular portion 57 to undergo radial elastic deformation. Since its inside diameter is larger than the outside diameter of the sleeve portion 24, the above-mentioned insertion portion 58A has the capability to facilitate insertion of the sleeve portion 24 and, at the same time, also has the capability to receive section 21A-1 (see FIGS. 5, 6), whose upper face rises in a slanted stepped manner posteriorly of the above-mentioned sleeve portion 24.

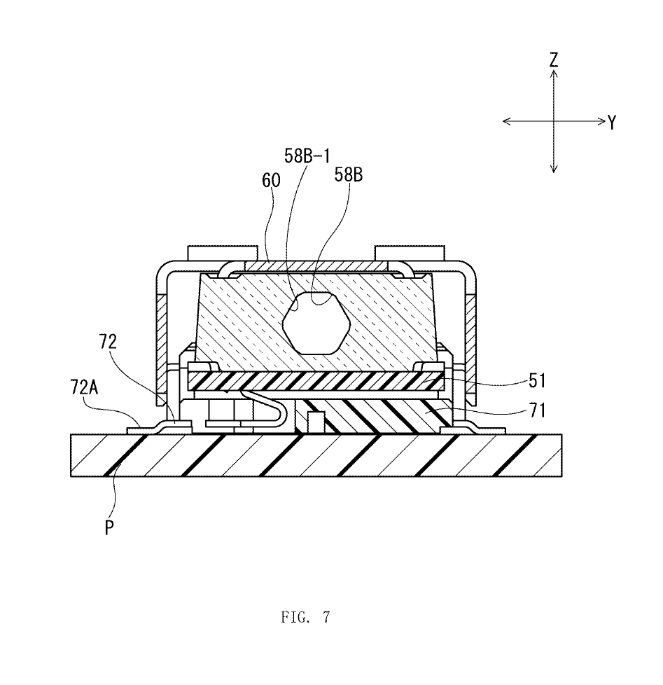

The receiving opening 58B has formed locally therein planar portions 58B-1 at multiple locations in the circumferential direction of the cylindrical opening (see FIG. 7), with the distance between said planar portions 58B-1 and the axial centerline of the receiving opening 58B being smaller than the radius of the base circle (circle including arcuate sections located between pairs of planar portions 58B-1 in the circumferential direction) of the above-mentioned cylindrical opening. The above-mentioned distance is smaller than the radius of the outer periphery of the sleeve portion 24 obtained when the elastic retaining pieces 24C of the fiber optic plug I are in a free state.

On the bottom wall of the above-mentioned receiving opening 58B, the inner bottom face of the receiving opening 58B forms a lens portion 59A with a convex spherical surface, and the outer bottom face forms an inclined reflection surface 59B. Said reflection surface 59B is located above the above-mentioned light-receiving element 52. When the sleeve portion 24 of the fiber optic plug I enters the above-mentioned receiving opening 58B all the way to its normal position, optical signals emitted from the front end of the core 1A of the optical fiber 1 secured in place in the sleeve portion 24 are focused by the above-mentioned lens portion 59A and reflected by the above-mentioned inclined reflection surface 59B while being diverted downwardly so as to reach the light-receiving element 52. Due to the fact that in the above-mentioned second molding 56 the outer bottom face of the receiving opening 58B constitutes the reflection surface 59B, a space is formed in a rear area closer to the receiving portion 58 than the reflection surface 59B. The above-mentioned light-receiving element 52 is connected to the above-mentioned actuation device 53 with wires (not shown). The actuation device 53 is connected to terminals (not shown) provided on the board 51.

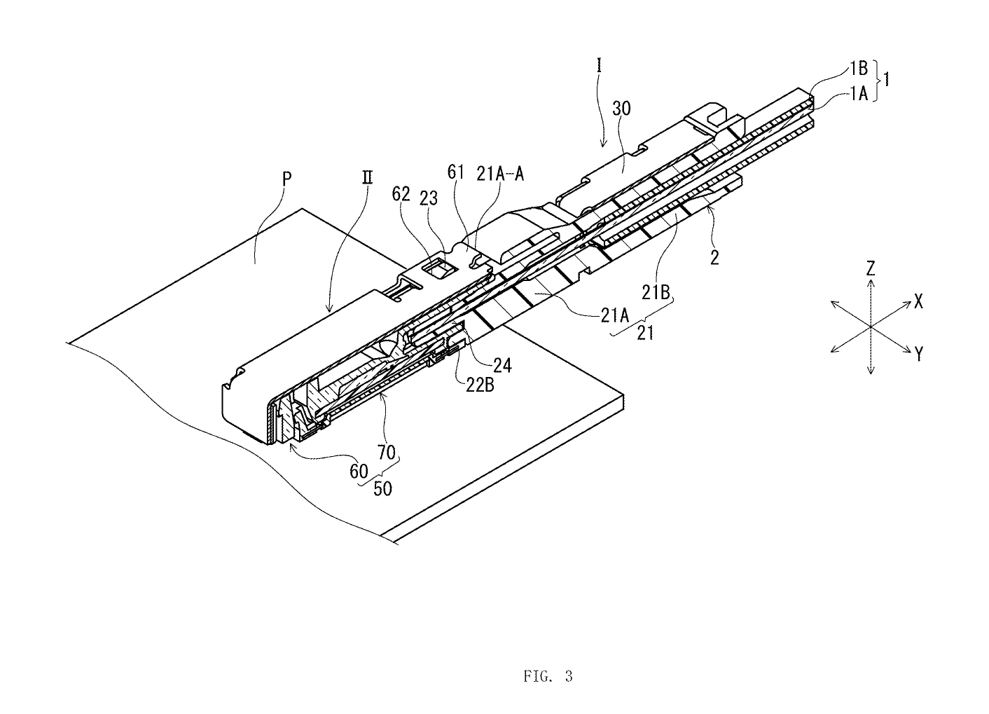

A metal cover 60 made of sheet metal is mounted to this second molding 56. Said metal cover 60 covers the upper face, both lateral faces, and the rear face of the above-mentioned second molding 56 and is open forwardly and downwardly. At the front end of the above-mentioned metal cover 60, there is provided a tab 61, which rises upward and protrudes forwardly in a crank-like configuration. At the same time, window-shaped engaging portions 62 are formed on the upper face (see FIGS. 1-4). When the above-mentioned fiber optic plug I is mated with the receptacle II, the above-mentioned tab 61 is brought in close proximity to the front end top edge 21A-1 (see FIG. 6) of the front portion 21A of the retaining portion 21 provided in the plug housing 2 of the fiber optic plug I and, as a result, is capable of restricting mating beyond the predetermined mating depth.

Window-shaped engaging portions 62 (see FIGS. 1-4) are formed in the above-mentioned metal cover 60 near the front end of said metal cover 60 at locations posterior of the above-mentioned tab 61. The barb-like engageable portions 23 formed at the front ends of the arm portions 26 of the plug housing 2 of the fiber optic plug I enter these portions and the engageable stepped portions 23B of said engageable portions 23 engage with the front edges of the apertures in these engaging portions 62, thereby preventing extraction of the fiber optic plug I from the receptacle II in the axial direction X.

As can be seen in FIG. 6, the mounting connector 70, which is mounted to the circuit board P and to which the above-described connector main body 50 is attached, has a base member 71 made of resin in the shape of a plate and surface-mount terminals 72 secured in place by said base member 71.

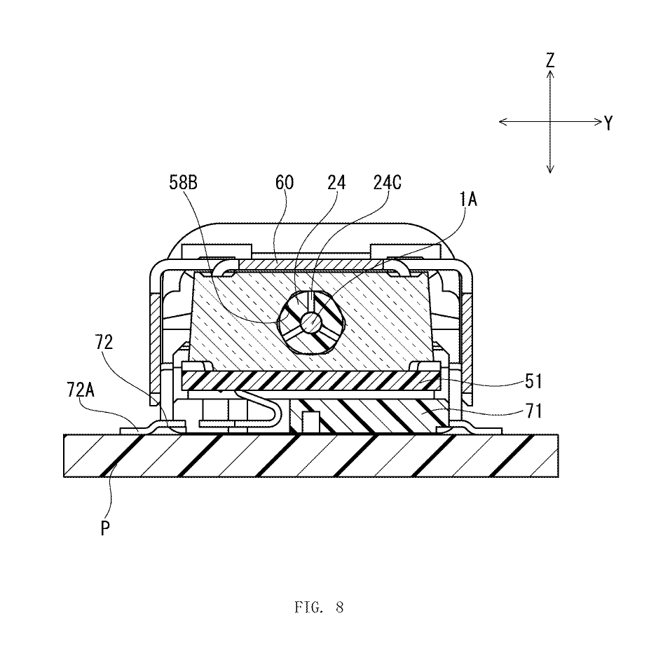

The above-mentioned surface-mount terminals 72, which are secured in place by the above-mentioned base member 71 and, as can be seen in FIGS. 7 and 8, are shaped in a substantially S-shaped configuration, have connecting portions 72A, whose lower ends are formed projecting outside from said base member 71, and contact portions (not shown), which are provided at the upper end and are brought in contact with the terminals (not shown) of the above-mentioned connector main body 50. The above-mentioned connecting portions 72A are solder-mounted to the circuit board P as the mounting connector 70, and the above-mentioned contact portions are brought in contact with, and electrically connected to, the terminals of the above-mentioned connector main body 50 when the connector main body 50 is mounted to said mounting connector 70 from above.

The thus-configured fiber optic plug I and receptacle II, to which the plug is connected, are used in the following manner.

First, the mounting connector 70 of the receptacle II is mounted to the circuit board P. Mounting is done by solder-connecting the connecting portions 72A of the surface-mount terminals 72 of said mounting connector 70 to the corresponding circuits on the circuit board P.

Next, the connector main body 50 is attached to the above-mentioned mounting connector 70, thereby completing the assembly of the receptacle II. As a result of attaching the connector main body 50, the terminals of said connector main body 50 are brought in contact with and connected to the surface-mount terminals 72 of the mounting connector, thereby electrically connecting the terminals of the connector main body 50 to the circuitry of the circuit board P via the surface-mount terminals 72.

Subsequently, the fiber optic plug I is mated with the above-mentioned receptacle II to form a fiber optic connection assembly (see FIGS. 5, 6). In the process of mating, the sleeve portion 24 of the fiber optic plug I initially enters the receiving portion 58 of the receptacle II. However, in said receiving portion 58, the inside diameter of the insertion portion 58A, which constitutes its front portion, is larger than that of the sleeve portion 24, and, for this reason, the radial placement of the sleeve portion 24 within the range of said insertion portion 58A is undefined. When the distal end of the sleeve portion 24 approaches the location of the rear end of the above-mentioned insertion portion 58A, i.e., the front end (entrance) of the receiving opening 58B, the lower guided portion 22B of the fiber optic plug I starts entering the space formed directly below the receiving tubular portion 57 of the receptacle II and, in addition, the upper guided portions 22A formed in the arm portions 26 start entering the corresponding space. The lower guided portion 22B enters in the axial direction X while being positioned in the heightwise direction Z, and the upper guided portions 22A are positioned in the width direction Y. This produces a state in which the location of the axial centerline of the sleeve portion 24 coincides with the location of the axial centerline of the receiving portion 58. In this manner, the sleeve portion 24 is positioned in the width direction Y and in the heightwise direction Z and, furthermore, enters and reaches the front end location of the receiving opening 58B. The inside diameter of the receiving opening 58B is set with the help of its planar portions 58B-1 such that it is slightly smaller than the outside diameter of the sleeve portion 24 obtained when said sleeve portion 24, which supports the core 1A, is not subject to external forces acting to reduce its diameter from outside. When the sleeve portion 24 is push-fitted into this receiving opening 58B, the multiple elastic retaining pieces 24C of the sleeve portion 24 are subject to forces acting radially inward from the above-mentioned receiving opening 58B, which produces slight elastic flexural deformation directed radially inward. In other words, the sleeve portion 24 is reduced in diameter, and, as a result, said sleeve portion 24 secures the core 1A rigidly in place (see FIGS. 5, 8). Since the above-mentioned elastic retaining pieces 24C have a cantilever configuration with free front ends, their elastic flexural deformation is greatest at the front end, where a minimum inside diameter portion is formed. In other words, the holding force of the sleeve portion 24 on the core 1A reaches a maximum point at the front end.

Thus, the sleeve portion 24 is introduced all the way to a predetermined advanced position while rigidly securing the core 1A in place, and the stepped portion 22B-1 located in the lower portion of the retaining portion 21 of the fiber optic plug I abuts the corresponding portion of the mounting connector 70 of the receptacle II, thereby determining the most advanced position of the above-mentioned sleeve portion 24, i.e., the predetermined mating position of the fiber optic plug I (see FIG. 6). In addition, the front end top edge 21A-1 located at the top of the retaining portion 21 is brought in close proximity to the tab 61 of the metal cover 60 of the receptacle II, thereby avoiding excessive advancement. In this predetermined mating position, the upwardly oriented raised engageable portions 23 formed on the arm portions 26 of the fiber optic plug I engage the window-shaped engaging portions 62 formed in the metal cover 60 of the receptacle II, thereby reliably preventing extraction of the fiber optic plug I.

When the fiber optic plug I is mated with the receptacle II at the predetermined mating position, the front end face of the core 1A protruding from the front end of the sleeve portion 24 faces the lens portion 59A of the receptacle II. In this manner, optical signals emitted from the fiber optic plug I are projected from the core 1A to the lens portion 59A, focused, reflected by the reflection surface 59B, and diverted downward, where they are converted to electrical signals by the light-receiving element 52 and transmitted from the actuation device 53 to the circuit board P via the terminals and surface-mount terminals 72.

In this manner, the fiber optic plug I and the receptacle II are mated to form a fiber optic connection assembly.

The present invention can be modified beyond the illustrated and described examples.

First, when the core 1A of the optical fiber 1 is secured in place by the sleeve portion 24, the front end of the core 1A does not need to protrude from the sleeve portion 24 and may be at the same position as the front end of the sleeve portion 24. This is due to the fact that, during the mating of the fiber optic plug I with the receptacle II, the multiple elastic retaining pieces 24C forming the sleeve portion 24 undergo elastic deformation in the radial inward direction, and the front ends of said elastic retaining pieces 24C, which form a minimum inside diameter portion, reliably and firmly hold the above-mentioned core 1A. Therefore, the sleeve portion 24 formed by the multiple elastic retaining pieces 24C may have a tapered expanded-diameter portion formed at the front end of said sleeve portion 24 while its inside diameter remains uniform in the axial direction X. Even though said tapered expanded-diameter portion, at its rear end, has the same inside diameter as the inside diameter of the sleeve portion 24, due to the fact that the elastic retaining pieces 24C have a cantilever configuration during elastic deformation, the largest amount of elastic flexural deformation is located at the rear end of the above-mentioned tapered expanded-diameter portion, where the minimum inside diameter portion of the sleeve portion 24 is formed.

The core of the optical fiber may be made of a glass material and resin. If the core is made of resin, the fiber is readily amenable to cutting and other types of processing and, consequently, is widely used. If such resin is used, severing the front end of the core may cause a slight sag in the radial direction due to shear, but if the above-mentioned tapered expanded-diameter portion is formed at the front end of the sleeve portion 24, then this sagging section is conveniently contained within the tapered expanded-diameter portion.

Next, although this is the minimum inside diameter portion of the sleeve portion 24, a minimum inside diameter portion may be formed by providing a projection or a protruding annular portion on the inner diameter surface of the sleeve portion 24. In such a case it is preferable for said minimum inside diameter portion to be formed in the vicinity of the front end of the sleeve portion 24.

Next, although in the illustrated examples the plug housing 2 had a retaining portion 21, guided portions 22, and engageable portions 23 formed as a single piece, this does not need to be the case and at least one of the retaining portion, guided portions, and engageable portions may be formed separate from other elements and then assembled therewith.

Furthermore, in the receptacle II, the sections of the receiving portion 58 intended to make its inside diameter smaller than the outside diameter of the sleeve portion 24 of the fiber optic plug I do not have to be the illustrated planar portions 58B-1, and convex surfaces may be used instead.

### DESCRIPTION OF THE REFERENCE NUMERALS

2 Plug housing
21 Retaining portion
22 Guided portion
23 Engageable portion
24 Sleeve portion
24B Slit
24C Elastic retaining piece
58 Receiving portion
58B-1 Planar portion
I Fiber optic plug
II Receptacle

1. A fiber optic plug comprising:
a plug housing, which secures a fiber optic cable in place and engages with a receptacle serving as a counterpart connector component, comprising a retaining portion securing the fiber optic cable in place, guided portions guided by receiving portions formed in the receptacle, and engageable portions engaging with the receptacle and preventing extraction after mating, wherein:
the retaining portion has a cylindrical sleeve portion that secures in place a core exposed by stripping a sheath from a front end portion of the fiber optic cable; said sleeve portion, at multiple locations in the circumferential direction, has provided therein multiple elastic retaining pieces formed having slits extending from an intermediate location in the axial direction of said sleeve portion to its front end; the sleeve portion has a minimum inside diameter portion formed in the inside diameter during elastic displacement of the elastic retaining pieces throughout the extent of the slits in the axial direction, and, during the mating of the retaining portion with the receptacle, while the front end of the core is at a position located forwardly of the minimum diameter portion or at the same position as said minimum inside diameter portion, the sleeve portion is subject to forces originating in the receptacle, and the elastic retaining pieces are elastically displaced in the radial inward direction of said sleeve portion, thereby securing the core in place.

2. The fiber optic plug according to claim 1, wherein the retaining portion, guided portions, and engageable portions of the plug housing are formed as a single member or, alternatively, formed as separate members and then integrally assembled together.

3. A fiber optic connection assembly comprising:
a fiber optic plug comprising
a plug housing, which secures a fiber optic cable in place and engages with a receptacle serving as a counterpart connector component, comprising a retaining portion securing the fiber optic cable in place, guided portions guided by receiving portions formed in the receptacle, and engageable portions engaging with the receptacle and preventing extraction after mating, wherein:
the retaining portion has a cylindrical sleeve portion that secures in place a core exposed by stripping a sheath from a front end portion of the fiber optic cable; said sleeve portion, at multiple locations in the circumferential direction, has provided therein multiple elastic retaining pieces formed having slits extending from an intermediate location in the axial direction of said sleeve portion to its front end; the sleeve portion has a minimum inside diameter portion formed in the inside diameter during elastic displacement of the elastic retaining pieces throughout the extent of the slits in the axial direction, and, during the mating of the retaining portion with the receptacle, while the front end of the core is at a position located forwardly of the minimum diameter portion or at the same position as said minimum inside diameter portion, the sleeve portion is subject to forces originating in the receptacle, and the elastic retaining pieces are elastically displaced in the radial inward direction of said sleeve portion, thereby securing the core in place,
and a receptacle with which said fiber optic plug is mated, wherein the receptacle comprises a receiving portion that receives the cylindrical sleeve portion provided in the retaining portion of the plug housing, and said receiving portion is formed as a cylindrical opening having a section with an inside diameter smaller than the outer peripheral surface of the sleeve portion.

4. The fiber optic connection assembly according to claim 3, wherein the receiving portion of the receptacle is formed as a cylindrical opening having multiple planar portions distributed in the circumferential direction along its inner peripheral surface, and the distance between the axial line of said cylindrical opening and said planar portions is made smaller than the radius of the outer peripheral surface of the sleeve portion of the fiber optic plug.
